(19) United States
(12) Patent Application Publication
(10) Pub. No.: US 2002/0025423 A1
(43) Pub. Date: Feb. 28, 2002

(54) Method of fabricating a composite part including a resin impregnated fiber shell and an expandable syntactic foam core

(76) Inventors: Michael A. Dreher, Durham, NH (US); James H. Dreher, Durham, NH (US); Coleen M. Fuerst, Durham, NH (US); Robert P. Dreher, Durham, NH (US)

Correspondence Address: John S. Beulick, Armstrong Teasdale LLP, Suite 2600, One Metropolitan Sq., St. Louis, MO, 63102, US

(21) Appl. No.: 09/903,891

(22) Filed: Jul. 12, 2001

Related U.S. Application Data
(60) Provisional application No. 60/219,837, filed on Jul. 21, 2000.

(51) Int. Cl. B29C 67/20; B29C 70/28; B32B 5/20; C08J 9/00

(52) U.S. Cl. 428/318.4; 264/46.4; 428/319.3; 521/56

(57) ABSTRACT

A method of manufacturing a composite article includes applying at least one resin impregnated fiber sheet to an inner surface of a forming mold, applying a predetermined mass of a syntactic foam mixture on at least a portion of the resin impregnated fiber sheets, closing the forming mold and heating the mold, the resin impregnated fiber sheets and the syntactic foam mixture to a predetermined temperature for a time sufficient to fully cure the resin impregnated fiber sheet and the syntactic foam to form the composite article. The syntactic foam mixture is formulated so that during the cure cycle, the syntactic foam gels, expands, and starts to cure before the resin impregnated fiber sheets of the outer shell. The expansion of the inner core of syntactic foam forces the fiber sheets of the shell against the inner surface of the mold to accurately reproduce the mold contours.

### CROSS REFERENCE TO RELATED APPLICATIONS

This application claims the benefit of U.S. Provisional application Ser. No. 60/219,837 filed Jul. 21, 2000.

### BACKGROUND OF THE INVENTION

This invention relates generally to compression molding processes, and more particularly, to a one step compression molding process of fabricating a heat cured composite part having an outer resin impregnated fiber shell and an expandable syntactic foam core.

Known composite parts of this type are typically formed in two steps. First an inner core is formed from a suitable material, for example, a urethane foam. Next, the preformed foam and an outer shell is compression molded together thereby bonding the preformed core and the shell together. Known shells are made from fiber reinforced resins.

Problems can arise when the preformed urethane foam core and the shell are compression molded together using a molding die. Particularly, because of low compression strength, the polyurethane foam can be crushed during the compression molding process and form defects in the form of voids in the surface of the outer shell.

Takaharu et al. in U.S. Pat. No. 5,007,643 describe that making the preformed core from a syntactic foam can overcome the problems of using urethane foams to form a composite article, for example a golf club head. However, the golf club head described by Takaharu et al. is fabricated in two steps like known urethane foam composite articles. First a syntactic foam preformed core is made. Then the preformed core is compression molded together with an outer shell.

It would be desirable to provide a method of fabricating a composite article having a foam core and an outer shell together without pre-forming the foam core. Additionally, it would be desirable to provide a method of fabricating a composite article with a Class A finish that requires very little or no secondary finishing of the outer surface of the shell, other than flashing removal.

### BRIEF SUMMARY OF THE INVENTION

In an exemplary embodiment of the present invention, a composite article is fabricated by a method where a syntactic foam core and a resin impregnated fiber outer shell are formed together without pre-forming the syntactic foam core. An exemplary method includes applying at least one resin impregnated fiber sheet to an inner surface of a forming mold, and then applying a predetermined mass of a syntactic foam mixture on at least a portion of the resin impregnated fiber sheets in the mold. The forming mold is closed and the mold, the resin impregnated fiber sheets and the syntactic foam mixture are heated to a predetermined temperature for a time sufficient to fully cure the resin impregnated fiber sheet and the syntactic foam to form the composite article.

The syntactic foam mixture is formulated so that during the cure cycle, the syntactic foam gels, expands, and starts to cure before the resin impregnated fiber sheets of the outer shell. The expansion of the syntactic foam inner core generates pressure that forces the fiber sheets of the shell against the inner surface of the mold to accurately reproduce the mold contours.

The above described method of fabricating a composite article eliminates the need for a preformed syntactic foam core which eliminates a step in the manufacturing process. Additionally, because the syntactic foam starts to gel, expands and starts to cure before the soft and moldable resin impregnated fiber sheets of the outer shell, the outer shell is forced against the inner surface of the mold to accurately reproduce the desired surface characteristics. This action produces a composite article with an outer surface having a Class A finish which does not require multiple finishing steps after molding.

### BRIEF DESCRIPTION OF THE DRAWINGS

FIG. 1 is a top view of a two-part compression mold shown in an open position in accordance with an embodiment of the present invention.

FIG. 2 is an exploded view of the layers of a composite article fabricated in accordance with an embodiment of the present invention using the compression mold shown in FIG. 1.

### DETAILED DESCRIPTION OF THE INVENTION

In one aspect, the present invention is directed to methods of fabricating composite articles. In another aspect, the present invention is directed to composite articles having a syntactic foam core and a resin impregnated fiber outer shell formed by methods that include forming the syntactic foam core and the resin impregnated fiber outer shell together at the same time in a forming mold. The methods of the present invention eliminate the added step of fabricating a pre-formed foam core prior to forming the composite article.

It should be understood that the methods of the present invention are used to form a variety of composite articles. Examples of composite articles formed by the methods of the present invention include, but are not limited to, rowing scull oar blades, sweep oar blades, rowing seats, non-tubular boat rigging parts, boat hulls, scooter tops, kayak and canoe paddles, baseball and softball bats, golf club heads, motorized vehicle parts, such as, all-terrain vehicle parts, motorcycle parts, and automobile parts, motorized aquatic vehicle parts, such as, jet ski parts, and the like. Of course, any other article that can be fabricated as a cored composite article can be fabricated by the methods of the present invention.

An embodiment of the present invention includes a method of fabricating a composite article having a syntactic foam core and a resin impregnated fiber outer shell. An exemplary method includes applying at least one resin impregnated fiber sheet to an inner surface of a forming mold, and then applying a predetermined mass of a syntactic foam mixture on at least a portion of the resin impregnated fiber sheets in the mold. The forming mold is closed and the mold, the resin impregnated fiber sheets and the syntactic foam mixture are heated to a predetermined temperature for a time sufficient to fully cure the resin impregnated fiber sheet and the syntactic foam to form the composite article. The mold and composite article are cooled and then the composite article is removed from the mold.

In one embodiment, the cure temperature of the composite article is about 230° F. to about 325° F. In another embodiment, the cure temperature is about 240° F. to about 310° F. In still another embodiment, the cure temperature is about 245° F. to about 300° F. In one embodiment, the ramp-up schedule for raising the composite part to the desired cure temperature is about 1° F. to about 50° F. per minute. In another embodiment, the ramp-up schedule is about 1° F. to about 15° F. per minute. In still another embodiment, the ramp-up schedule is about 2° F. to about 10° F. per minute.

To effect a complete cure, the composite article is maintained at the cure temperature from 0 to about 90 minutes. In another embodiment the composite article is maintained at the cure temperature from 0 to about 60 minutes. The cure times are selected based on the part thickness and the composition of the syntactic foam core and the outer shell of the composite article.

Before removing the composite article from the mold, the composite article is cooled to between about ambient temperature to about 100 percent of the cure temperature. In an alternative embodiment, the composite part is cooled to between about 10 percent to about 100 percent of the cure temperature.

The syntactic foam mixture is formulated so that the syntactic foam gels at a lower temperature than the shell material so that during the cure cycle, the syntactic foam gels, expands, and starts to cure before the resin impregnated fiber sheets of the outer shell. The expansion of the inner core of expandable syntactic foam forces the fiber sheets of the shell against the inner surface of the mold to accurately reproduce the mold contours. When the inner surface of the mold is polished, a smooth Class A finish is produced on the outer surface of the composite part. When the inner surface of the mold is, for example, burnished, etched, or textured, the outer surface of the composite part mirrors the surface condition of the inner surface of the mold.

Additionally, the cure rate of the syntactic foam mixture and the cure rate of the resin impregnated fiber sheets of the outer shell are adjusted so that the core cures before the outer shell. During the heating of the mold and curing of the composite article, the outer shell typically reaches a higher temperature before the syntactic foam inner core. Because of the differences in gradient dynamics between different composite articles, the formulations of the resin impregnated fiber sheets and the syntactic foam core are adjusted, usually by modifying the concentrations and choice of curing agents and accelerators or catalysts to achieve a desired timing of cure rates and, to produce a fully cured composite article at the completion of the cure cycle.

The outer shell of the composite part includes one or more layers of resin impregnated fiber sheets. Any suitable resin impregnated fiber sheets can be used. In one embodiment, the resin impregnated fiber sheets are pre-preg composite sheets. The resin impregnated fiber sheets include unidirectional, chopped, or woven fibers of, for example, carbon fibers, aramid fibers (aromatic polyamid fibers), glass fibers, and combinations thereof. In one embodiment, pre-preg sheets are formed, for example, by impregnating the sheet of fibers with resin by pulling the sheets through a plurality of resin coated heated rollers to coat the fibers and then the resin is permited to partially cure, or “B-stage”. The resulting pre-preg sheet is malleable and easily formed in a mold. Suitable resins for impregnating the fiber sheets include, but are not limited to, thermosetting resins, for example, vinyl ester resins, epoxy resins, and unsaturated polyester resins.

In accordance with the design specifications of molded composite articles, the type, dimensions, location, and orientation of the plies of resin impregnated fiber sheets within the shape confines of the various composite articles are used to define the structural characteristics of the composite articles. The dimensions, and location of one or more plies of composite sheet are used to define and/or adjust the overall weight, and center of gravity of the composite article. For example, with a rowing oar blade, it is desirable to provide one or more layers of resin impregnated fiber sheets in a certain position within the blade to adjust the center of gravity to compensate for the asymmetrical nature of present rowing oar blade designs. This permits the user to row more efficiently and easily. Additionally, it is often desirable to provide extra layers of resin impregnated fiber sheets in certain areas to reinforce and strengthen a portion of the composite article or to make the area more resistant to impact or abrasion. For example, it is desirable to provide additional layers of resin impregnated fiber sheets at the tip of an oar blade to provide scuff resistance and to provide additional layers of resin impregnated fiber sheets for reinforcement at the end of the oar blade where the oar shaft attaches to the oar blade.

The syntactic foam is made from a mixture of various components. The syntactic foam mixture includes a resin or mixture of resins, for example vinyl ester resins, epoxy resins, and unsaturated polyester resins. In one embodiment, the resin is present in the syntactic foam mixture from about 30 to about 75 percent by weight, and in another embodiment from about 40 to about 60 percent by weight.

The syntactic foam mixture also includes micro-balloons. The micro-balloons can be glass micro-balloons, expanding gas encapsulated thermoplastic micro-balloons, or a mixture thereof. Glass micro-balloons can be present in the syntactic foam mixture of from 5 to about 40 percent by weight, and in another embodiment from about 10 to about 30 percent by weight. Glass micro-balloons are commercially available, for example, from 3M Corporation. The expanding gas encapsulated thermoplastic micro-balloons can be present in the syntactic foam mixture of from 0 to about 30 percent by weight, and in another embodiment from about 5 to about 25 percent by weight. The amount of the expanding gas encapsulated micro-balloons present in the mixture controls the amount and rate of expansion of the syntactic foam. Expanding gas encapsulated micro-balloons are commercially available from Akzo Nobel under the trade name EXPANCELL.

The syntactic foam mixture also includes from about 0.5 to about 10 percent by weight of a curing agent. Suitable curing agents include isocyanates including diisocyanates and polyisocyanates, amines, and mixtures thereof.

The syntactic foam mixture can also include pigments for color, and other additives such as fillers, foaming agents, accelerators, catalysts, modifiers and diluents. The fillers can be structural fillers for structural strength, such as, for example, chopped fibers, and non-structural fillers, such as, for example, fumed silica. Each of the above described additives can be present in the syntactic foam mixture up to about 25 percent by weight.

As described above, the weight and center of gravity of the composite article can be adjusted with extra layers of pre-preg composite sheets of by using pre-preg composite sheets of different density for different areas of the outer shell. Additionally, the weight and center of gravity of the composite article can be adjusted by having a core formed from multiple layers of varying density syntactic foam mixtures. Further, the weight and center of gravity of the composite article can be adjusted by introducing a weighted material into the core.

The present invention will be further described by reference to the following example which is presented for the purpose of illustration only and is not intended to limit the scope of the invention.

### EXAMPLE

The example shows the fabrication of a rowing shell seat in accordance with an embodiment of the present invention.

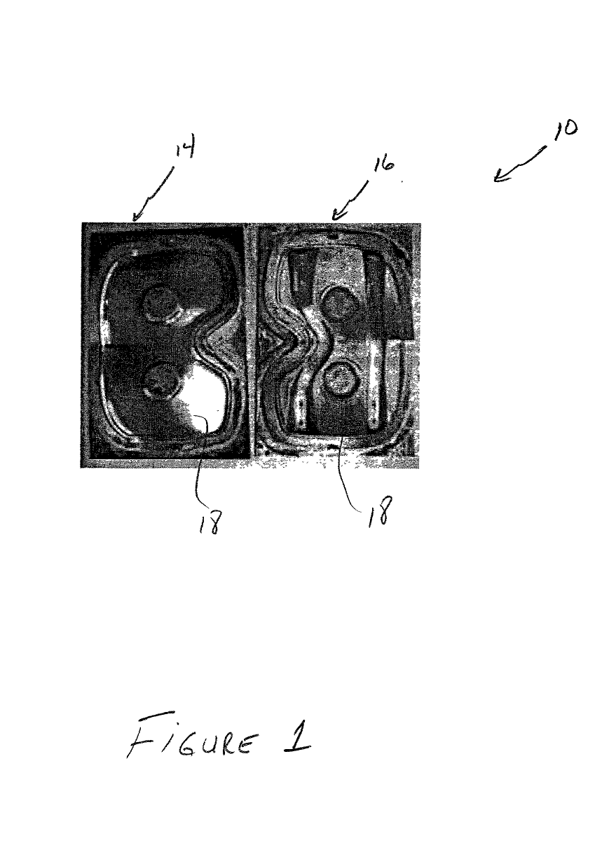

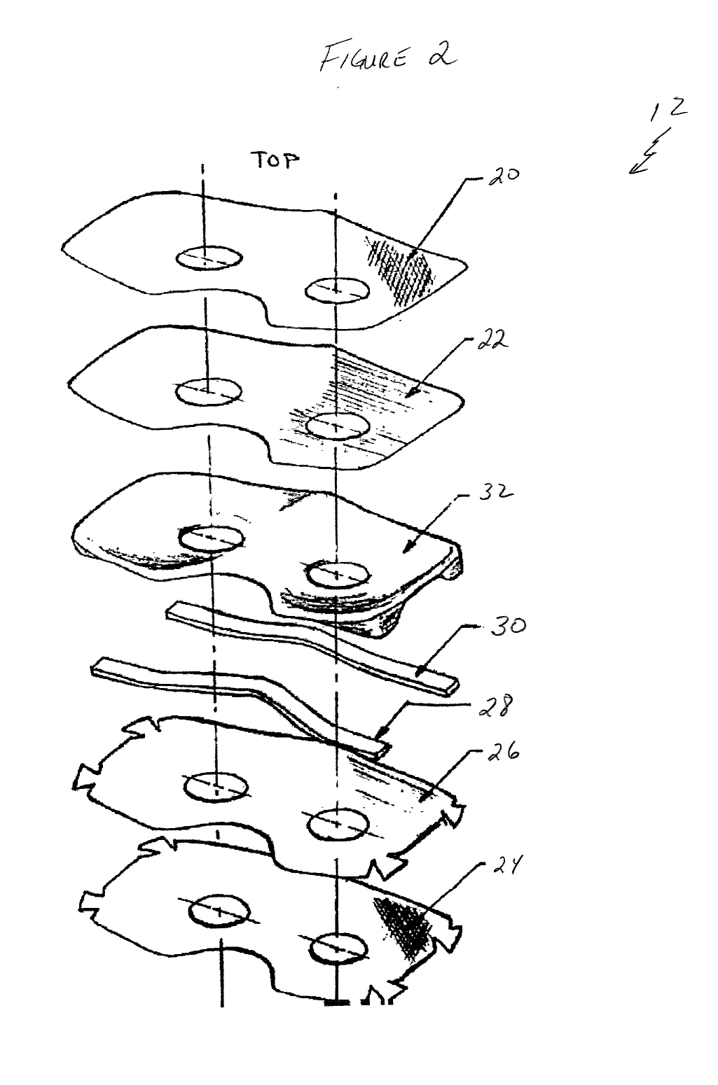

FIG. 1 is a top view of a compression mold 10 for a rowing shell seat 12 (shown in FIG. 2). Mold 10 is shown in an open position. Mold 10 includes a top mold part 14 and a bottom mold part 16. The inside surface 18 of mold 10 is contoured to enable mold 10 to produce the contours of seat 12. Additionally, inside surface is polished to permit the formation of seats having a Class A finish. Top mold part 14 is sized and configured to mate with bottom mold part 16 forming a cavity that receives the materials used to form seat 12.

FIG. 2 is an exploded view of the layers of composite rowing shell seat 12 fabricated in mold 10. Rowing seat 12 includes a first top layer 20, a second top layer 22, a first bottom layer 24, a second bottom layer 26, two reinforcing strips 28 and 30, and an expandable syntactic foam core 32 (shown as shaped after molding).

First top layer 20 and first bottom layer 24 are resin impregnated woven carbon fiber sheets commercially available from SP Systems as PZR13-002. Second top layer 22 and second bottom layer 26 are resin impregnated unidirectional carbon fiber sheets commercially available from Newport Composites as TR50 12K. Reinforcing strips 28 and 30 are seven ply strips of the same unidirectional carbon fiber pre-preg material as second bottom layer 26.

Expandable syntactic foam core 32 was formed from a mixture of the following ingredients.

| Ingredient | % By Weight |
|---|---|
| EPON 828 Epoxy Resin¹ | 42.9 |
| Diluent² | 8.6 |
| Carbon Black Pigment³ | 2.1 |
| Amine Curing Agent⁴ | 10.7 |
| EXPANCELL Micro-Spheres⁵ | 15.1 |
| Chopped Fiber Structural Filler⁶ | 2.1 |
| Micro-Balloons⁷ | 18.5 |

¹Commercially available from Shell.
²Commercially available from Shell as HELOXY 505.
³Commercially available from American Colors, Inc.
⁴Commercially available from Air Products as H 2441.
⁵Commercially available from Akzo Nobel
⁶½ inch chopped carbon fibers commercially available from LBI.
⁷Commercially available from 3M Corporation.

Expandable syntactic foam mixture, described above, was applied between second top layer 22 and second bottom layer 26. Top mold part 14 and bottom mold part 16 were closed to form mold 10 with top layers 20 and 22, bottom layers 24 and 26, reinforcing strips 28 and 30, and expandable syntactic foam mixture of core 32 positioned inside closed mold 10.

Mold 10 was then heated to a temperature of 260° F. The temperature ramp-up was 10° F. per minute. Mold 10 was maintained at 260° F. for 25 minutes to cure composite rowing shell seat 12. Mold 10 was then cooled to 60 percent of the cure temperature (approximately 155° F.) and seat 12 was removed from mold 10.

Composite rowing seat 12 exhibited excellent strength and had an exterior surface that exhibited a Class A surface finish right out of mold 10 without any finishing. Rowing seat 12 did not require any secondary finishing steps except for the removal of the mold flash.

While the invention has been described in terms of various specific embodiments, those skilled in the art will recognize that the invention can be practiced with modification within the spirit and scope of the claims.

What is claimed is:

1. A method of manufacturing a composite article including a syntactic foam core and a resin impregnated fiber shell, said method comprising:
providing a forming mold including an inner surface;
applying at least one resin impregnated sheet to the inner surface of the forming mold;
applying a predetermined mass of a syntactic foam on at least a portion of the at least one resin impregnated fiber sheet in the mold;
closing the mold; and
heating the closed mold to a predetermined temperature for a time sufficient to fully cure the resin impregnated fiber sheet and the syntactic foam to form a composite article.

2. A method in accordance with claim 1 wherein the inner surface of the mold is polished.

3. A method in accordance with claim 1 wherein the inner surface of the mold is burnished, etched, or textured.

4. A method in accordance with claim 1 wherein the syntactic foam comprises a mixture of:
at least one epoxy resin;
at least one curing agent; and
expandable gas encapsulated thermoplastic micro-spheres.

5. A method in accordance with claim 4 wherein the syntactic foam mixture further comprises at least one of a curing agent and an accelerator.

6. A method in accordance with claim 4 wherein the syntactic foam mixture further comprises at least one of a blowing agent and a foaming agent.

7. A method in accordance with claim 4 wherein the syntactic foam mixture further comprises a pigment.

8. A method in accordance with claim 1 wherein heating the closed mold comprises heating the closed mold to between about 200° F. and about 350° F. for about 1 to about 90 minutes.

9. A method in accordance with claim 1 wherein heating the closed mold comprises heating the closed mold to between about 240° F. and about 320° F. for about 1 to about 90 minutes.

10. A method in accordance with claim 1 wherein heating the closed mold comprises heating the closed mold at a temperature ramp-up schedule of about 1° F. per minute to about 50° F. per minute.

11. A method in accordance with claim 1 further comprising:
cooling the mold to a temperature of about 40 percent to about 90 percent of the cure temperature; and
removing the composite article from the mold.

12. A composite article comprising a syntactic foam core and a resin impregnated fiber shell, said composite article fabricated by a method comprising:
providing a forming mold comprising an inner surface;
applying at least one resin impregnated sheet to the inner surface of the forming mold;
applying a predetermined mass of a syntactic foam on at least a portion of the at least one resin impregnated fiber sheet in the mold;
closing the mold;
heating the closed mold to a predetermined temperature for a time sufficient to fully cure the resin impregnated fiber sheet and the syntactic foam to form a composite article.

13. A composite article in accordance with claim 12 wherein the inner surface of the mold is polished.

14. A composite article in accordance with claim 12 wherein the inner surface of the mold is burnished, etched, or tectured.

15. A composite article in accordance with claim 12 wherein the syntactic foam comprises a mixture of:
at least one epoxy resin;
at least one curing agent; and
expandable gas encapsulated thermoplastic micro-spheres.

16. A composite article in accordance with claim 15 wherein the syntactic foam mixture further comprises at least one of a curing agent and an accelerator.

17. A composite article in accordance with claim 15 wherein the syntactic foam mixture further comprises at least one of a blowing agent and a foaming agent.

18. A composite article in accordance with claim 15 wherein the syntactic foam mixture further comprises a pigment.

19. A composite article in accordance with claim 12 wherein heating the closed mold to a predetermined temperature for a time sufficient to fully cure the resin impregnated fiber sheet and the syntactic foam comprises heating the closed mold to between about 200° F. and about 350° F. for about 1 to about 90 minutes.

20. A composite article in accordance with claim 12 wherein heating the closed mold to a predetermined temperature for a time sufficient to fully cure the resin impregnated fiber sheet and the syntactic foam comprises heating the closed mold to between about 240° F. and about 320° F. for about 1 to about 90 minutes.

21. A composite article in accordance with claim 12 wherein heating the closed mold comprises heating the closed mold at a temperature ramp-up schedule of about 1° F. per minute to about 50° F. per minute.

22. A composite article in accordance with claim 12 wherein the method further comprises:
cooling to a temperature of about 40 percent to about 90 percent of the cure temperature; and
removing the composite article from the mold.

23. A molded composite article comprising a foam core and a resin impregnated fiber outer shell, said foam core formed from an expandable syntactic foam, said foam core and said outer shell molded together in one step.

24. A molded composite article in accordance with claim 23 wherein said expandable syntactic foam comprises a mixture of:
at least one epoxy resin;
at least one curing agent; and
expandable gas encapsulated thermoplastic micro-spheres.

25. A molded composite article in accordance with claim 23 wherein said expandable syntactic foam mixture further comprises an accelerator.

26. A molded composite article in accordance with claim 23 wherein said expandable syntactic foam mixture further comprises at least one of a blowing agent and a foaming agent.

27. A molded composite article in accordance with claim 23 wherein said expandable syntactic foam mixture further comprises a pigment.

28. An expandable syntactic foam composition comprising a mixture of:
at least one epoxy resin;
at least one curing agent; and
expandable gas encapsulated thermoplastic micro-spheres.

29. An expandable syntactic foam composition in accordance with claim 28 further comprising at least one of a curing agent and an accelerator.

30. An expandable syntactic foam composition in accordance with claim 28 further comprising at least one of a blowing agent and a foaming agent.

31. An expandable syntactic foam composition in accordance with claim 28 further comprising a pigment.

32. An expandable syntactic foam composition in accordance with claim 28 further comprising at least one of a structural filler and a non structural filler.
